(19) United States
(12) Patent Application Publication
(10) Pub. No.: US 2011/0085831 A1
(43) Pub. Date: Apr. 14, 2011

(54) Fuser for an Image-Forming Apparatus and Method of Using Same

(76) Inventors: David William Hullman, Lexington, KY (US); Brandon Alden Kemp, Lexington, KY (US); Niko Jay Murrell, Lexington, KY (US); Ryan James Nelson, Versailes, KY (US); Julie Ann Gorden Whitney, Georgetown, KY (US)

(21) Appl. No.: 12/578,183

(22) Filed: Oct. 13, 2009

(51) Int. Cl. G03G 15/20

(52) U.S. Cl. 399/329

(57) ABSTRACT

An image-forming device includes a belt-based fuser for fixing an image to a media substrate. The fuser includes a belt disposed about a heating element to facilitate the media handling and to transfer the heat of the heater to the passing media. A lubricant layer lubricates the movement of the belt about the heating element. The lubricant layer includes fluorinated oil having a number average molecular weight greater than 10,000 amu.

### BACKGROUND

1. Field of the Invention

The present invention relates to a fuser assembly for use in an image-forming apparatus, and to a method of using the described fuser assembly.

2. Description of the Background Art

During operation of an image-forming device such as a laser printer or copier, a fuser permanently affixes toner particles to a media substrate in the final stage of a non-impact image-forming process. When fusing toner onto a substrate, the toner must be heated to a point where the toner coalesces and appears tacky. The heat allows the toner to flow, thereby enabling it to coat the fibers or pores of the substrate. With the addition of pressure, an improved contact between the substrate and toner can be obtained. The heat and pressure required for fusing is achieved by a heated member and a pressure roller that under an applied force form a nip. Heat from the fuser melts the toner particles, while the applied pressure allows for absorption thereof into the media. Subsequent cooling of the toner, while it is in intimate contact with the substrate, allows it to adhere to the substrate in a semi-permanent manner.

The heating element of the fuser may be mounted/located inside a movable belt, in order to facilitate faster temperature response time and reduced energy usage by the image-forming device. However, during operation, sliding friction between the heating element and the belt introduces torque and wear that can lead to a reduction in component lifespan, as well as a possible reduction in image quality. While this friction may be mitigated through the application of a lubricant, the heat and pressure exerted on the components present significant challenges to the performance of the lubricant.

A number of improvements have been made in fuser assemblies and related technology. Examples of some publications in this area of technology include U.S. Pat. Nos. 6,157,806, 6,266,510, 6,456,819, 6,818,290, 7,106,986; and published U.S. patent applications 2006-0088324, 2008-0181626, 2008-0181687, 2009-0071913, and 2009-0074486.

While the known fusers are useful for their intended purposes, a need still exists for an improved lubricated fuser assembly exhibiting reduced torque and improved wear properties over time, and for a method of using such an improved fuser assembly.

### SUMMARY

An image-forming device includes a belt-based fuser for fixing an image to a media substrate. The fuser includes a heating element and a belt, which is disposed surrounding the heating element. The belt is configured and arranged to facilitate media handling, and to transfer heat from the heating element to the passing media. A thin grease layer is provided between the belt and the heating element to lubricate movement of the belt about the heating element. The grease layer includes a lubricant composition comprising a fluorinated oil having a number average molecular weight greater than 10,000 atomic mass units (amu). In a specific embodiment, the lubricant composition comprises a copolymer of polyperfluoromethylene oxide and polyfluoroethylene oxide.

### BRIEF DESCRIPTION OF THE DRAWINGS

The features and advantages of the various exemplary approaches of this disclosure, and the manner of attaining them, will become more apparent and better understood by reference to the accompanying drawings, wherein:

FIG. 1 is a system view of an exemplary image-forming device;

FIG. 2 is a side view of an exemplary belt fuser according to an illustrative example hereof;

FIG. 3 is a chart showing viscosity of selected lubricants over temperature at a 14.8/s Shear Rate; and

FIG. 4 is a chart showing a comparison of end-of-life torque resulting from the application of greases with different number-average molecular weights (Mn).

### DETAILED DESCRIPTION

It is to be understood that the following disclosure and claims are not limited in application to the details of construction and the arrangement of components set forth in the following description or illustrations. The disclosure is capable of other exemplary approaches and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

In addition, it should be understood that exemplary approaches described herein include both hardware and electronic components or modules that, for purposes of discussion, may be illustrated and described as if the majority of the components were implemented solely in hardware. However, one would recognize that, in at least one exemplary approach, the electronic based aspects of the disclosure may be implemented in software. As such, it should be noted that a plurality of hardware and software-based devices, as well as a plurality of different structural components may be utilized to implement the exemplary approaches described herein. Furthermore, and as described in subsequent paragraphs, the specific mechanical configurations illustrated in the drawings merely provide exemplary approaches, and those in the art will realize and appreciate that other alternative mechanical configurations are possible.

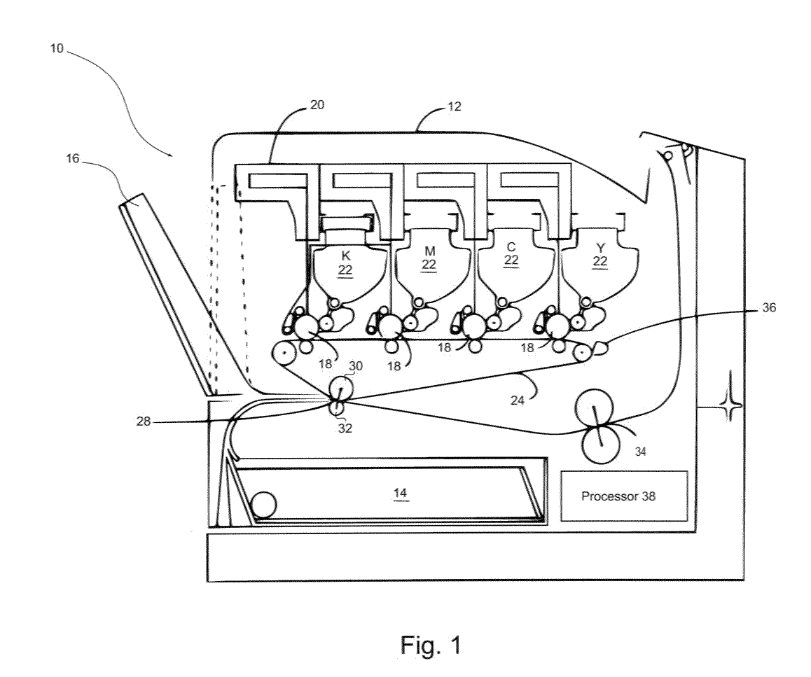

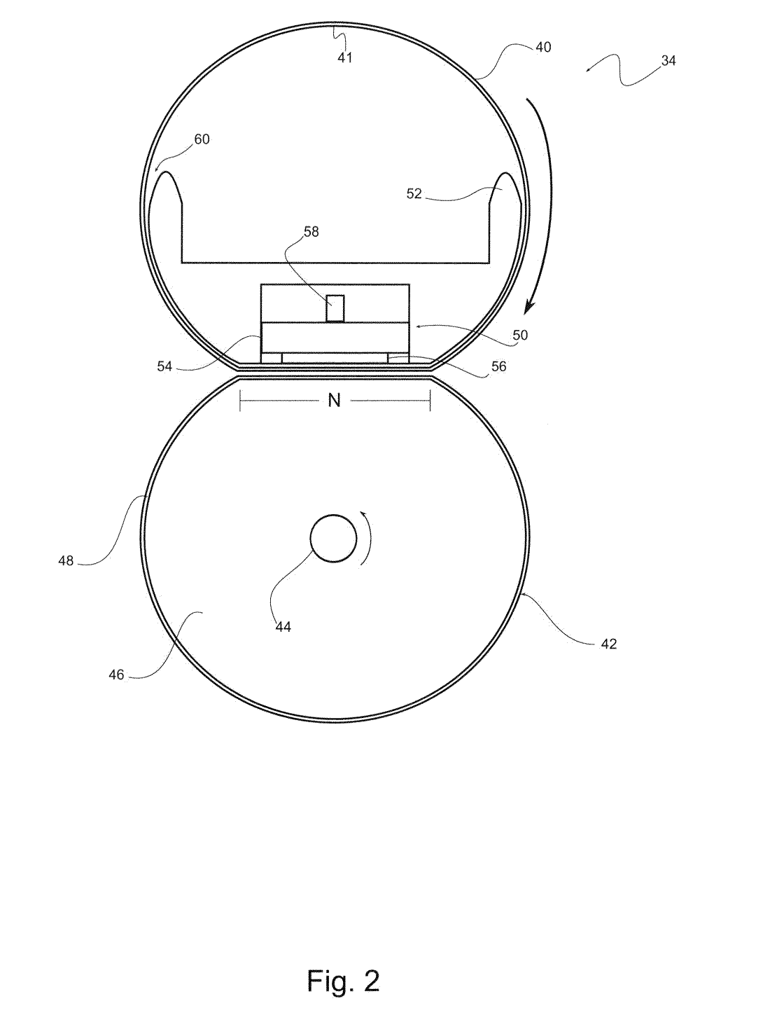

FIG. 1 depicts an exemplary image-forming device 10 that allows for an image to be formed on a media substrate by way of a multi-step image-forming process along a media path. A fuser 34, which fuses or fixes the image to the media in one of the final steps of the image-forming process will be discussed, along with the lubricant thereof, in detail below with respect to FIG. 2. The term “image-forming device,” and the like, is generally used herein as a device that produces images on printable media sheets. Examples include, but are not limited to, laser printers, LED printers, copy machines including laser copiers, etc. Commercially available examples of image-forming devices include Model Nos. C544, C750 and C752 of Lexmark International, Inc. of Lexington, Ky.

As shown in FIG. 1, the image-forming device 10 includes a main body 12 that houses media handling elements such as a media tray 14, a media sheet feeder 16, and various non-depicted belts and rollers. The main body 12 also houses imaging elements such as a plurality of photo-conductive drums 18, imaging devices 20, removable toner cartridges 22, an intermediate transfer belt 24, a secondary transfer point 28, a fuser 34, and a waste toner collector 36.

The cartridges 22 include the same sub-elements and are only distinguished by the color of the toner contained therein. As depicted, the image-forming device 10 includes four cartridges 22, respectively provided with the colors black (K), magenta (M), cyan (C), and yellow (Y). Each cartridge 22 forms an individual mono-color image that is combined, in a layered manner, with images from the other cartridges to create the final multi-colored image. Each cartridge 22, which may be individually removable, includes a reservoir holding a supply of toner and a developer roller for applying toner to the respective photo-conductive drum 18. The photo-conductive drum 18 may be an aluminum hollow-core drum coated with one or more layers of light-sensitive organic photo-conductive materials. The drum 18 may be charged over its entire surface, allowing for the imaging device 20 to discharge a portion of the surface with a laser beam or the like. The discharged portion of the drum 18 corresponds to the image that will be printed with toner from the respective cartridge 22.

Toner is drawn by electrostatic force from the developer roll of the cartridge 22 to the discharged portion of the drum 18. The endless intermediate transfer belt 24 rotates continuously in cooperation with the drums 18 of the respective cartridges 22. A potential difference between the belt 24 and the drums 18 forces the toner particles to move from each of the drums onto the belt 24. The belt 24 and drums 18 are synchronized, so that the toner from each drum precisely aligns to form a layered multi-colored image.

Media, such as e.g. paper, may be drawn either from the manual feeder 16 or from the media tray 14, and the selected medium is delivered along the media path to a secondary transfer point 28. The timing of the media arrival is synchronized with the arrival of the portion of the belt 24 carrying the completed image thereon, in order to transfer the toner from the belt to the media.

At the secondary transfer point 28, the toner and the media move through an electric field at the exact point of transfer, or transfer nip 28, which field is created between a positively-biased second transfer roller 32 and a grounded backup roller 30. At the transfer nip 28, the negatively charged toner particles become sandwiched between the belt 24 and the media. The electric field between the second transfer roller 32 and the backup roller 30 forces the toner to be released from the belt 24 and transferred onto the media. Subsequent to the toner transfer, the media passes through the fuser 34, which applies heat and pressure to permanently affix the toner to the media. A waste toner cleaner 36 removes any residual toner particles from the belt 24.

The above-described printing process may be controlled by a controller such as processor 38. While not depicted in detail, the processor 38 includes a processing unit and associated memory, and may be formed as one or more Application Specific Integrated Circuits (ASIC). The memory may be, for example, random access memory (RAM), read only memory (ROM), and/or non-volatile RAM (NVRAM). Alternatively, the memory may be in the form of a separate electronic memory (e.g., RAM, ROM, and/or NVRAM), a hard drive, a CD or DVD drive, or any memory device convenient for use with the processor 38. Regardless of the particular implementation, the memory provides a computer readable medium that may be encoded with computer instructions for controlling the processor 38 to carryout the printing process as well as the methods described below. The processor 38 may further include an I/O controller and I/O ports for communicating with an external computing or processing device. Moreover, computer instructions for implementing the image-forming process and the methods described herein may be provided to the device 10 via the I/O ports from a computer readable medium associated with the external processing device.

FIG. 2 depicts a cross-sectional, side view of an exemplary belt-based fuser 34. The fuser 34 includes an endless belt 40 that abuts against a pressing roller 42 along a fixing nip (N). The pressing roller 42 consists of a central shaft 44 typically formed from steel, aluminum, or similar metal; an intermediate rubber elastic layer 46 made of silicone rubber or silicone foam, and an external parting layer 48, typically consisting of a PFA perfluoroalkoxy copolymer sleeve. The pressing roller 42 urges the belt and any passing media into close proximity to the bottom surface of a heater 50, by way of a resilient member or other urging means (not shown). In one exemplary approach, the urging means provides a force of about 4 to 7 kilograms. The pressing roller 42 is driven by an attached gear (not shown) through connection with a gear series to the printer mechanism gear train. The rotation of the pressing roller 42 drives the belt 40, thereby moving media through the fixing nip (N).

The belt 40 is an endless flexible tube, which is continuously rotated by contact with the pressing roller 42 for fixing the toner image to a media substrate. The belt 40 is typically made of a highly heat-resistant and durable material having good parting properties. The belt 40 may be a thin metal tube of thickness of about 50 microns or less with a release coating such as polytetrafluoroethylene (PTFE) with or without a conformable intermediate layer such as silicone rubber. The belt 40 may also have a release coating of PFA with or without a conformable intermediate layer such as silicone rubber.

Alternatively, belt 40 may have a total thickness of not more than about 100 microns, preferably less than about 35 microns. To facilitate the parting with the media, leaving the toner on the media, the belt 40 typically has a conformable intermediate layer and an outer layer (not separately shown) of low surface energy material such as polytetrafluoroethylene or a similar fluoropolymer. A fluoropolymer primer layer is commonly used between the fluoropolymer topcoat and the polyimide layer. The belt 40 is usually electrically conductive.

The heater 50 may be embedded within a holder 52 that abuts the belt. The heater 50 includes a ceramic substrate or base member 54 that extends in a direction substantially perpendicular to the direction of movement of the belt 40 along the fixing nip (N). The base member 54, which is electrically insulative, has a low thermal conductivity and high heat-resistance. One or more heat-generating electrical resistors 56 are disposed in a line or strip extending along the length of the base member 54 on the lower surface thereof. A temperature-detecting element 58, such as for example, a thermistor or thermocouple, is mounted in contact with the back face of the base member 52 (opposite the face having the heat-generating resistors 56 thereon).

The heat retention of the heater 50, as a whole, is low. A thin layer of electrical insulation, such a glass (not shown), covers the heat generating resistor 56 portion of the bottom face of the heater 50, thereby coming in direct contact with an inner surface 41 of the belt 40 on the side thereof opposite the outer, parting layer of the belt.

To facilitate the contact between the belt 40 and the heater 50, as well as the holder 52, a thin layer of a lubricant composition 60 according to the present invention is disposed on the inner surface 41 of the belt 40. The applied layer of the lubricant composition 60 is thin in relation to the total thickness of the belt 40, and the grease is applied only in sufficient amount within the fusing nip over life of fuser. In one exemplary approach, the full amount for that purpose may be applied during manufacture on the bottom face of the heater 50. The belt 40 is then placed around the heater 50 and the holder 52.

In operation, the pressing roller 42 and the heater 50 are controlled by the processor 38. The heater 50 is operated at a temperature necessary to melt the toner in the fixing nip (N), with the heat thereof transferring through the belt 40. The pressure from the pressure roller 42 induces the melted toner to be absorbed into the media substrate. As the media exits the fixing nip (N), the belt 40 peels away from the media, leaving the fixed image imprinted thereon, and the belt continues around the heater holder 52.

The lubricant composition 60 is optimized for low torque and good oil retention in the nip of the fusing apparatus. The grease can withstand the high temperatures experienced in a fusing system with minimal oil loss and minimal lubricant degradation.

Overall, so-called “boundary lubrication,” or the loss of oil in the nip due to oil separation, is to be avoided in favor of “mixed lubrication.” Mixed lubrication improves the life and reduces performance issues observed during boundary lubrication. These performance issues include wear of the components and noise associated with a vibration that is amplified by the belt during a stick-slip phenomenon in the nip area. Moreover, certain wear debris in the nip area could build up and create unevenness in the nip, which could lead to print quality issues or even unacceptable damage of components.

The lubricant composition 60 supplied between the belt 40 and heater 50 should reduce torque and wear properties by maintaining mixed lubrication. The lubricant composition 60 may be a fluorinated oil that can withstand high temperatures (up to 260 C). The thickness of the lubricant composition 60 layer is optimized in a number of ways: through pressure of the fusing components, viscosity of the oil, filler content, molecular weight of the oil and chemical nature of the oil, as well as the filler type (material, size and shape). These properties that affect the layer thickness will be discussed in more detail below. It is optimal to have a thin enough layer for good thermal response between the heater device and the heated rotating member, yet thick enough to minimize wear and extend life.

In one exemplary approach, the lubricant composition 60 may include fluorinated oil having a high molecular weight (MW) as to maintain the desired “mixed lubrication” in the nip area. If the MW is too low the grease cannot be contained in the nip and the result would be “boundary lubrication,” which over time would result in vibration and high torque. The MW of a polymer, fluorinated oil, may be represented by the number average molecular weight (Mn). The Mn can be determined by end group analysis of fluorine using nuclear magnetic resonance (NMR) spectra on the base oil. In particular, the lubricant composition 60 may be fluorinated oil with a Mn of 10,000 to 50,000 atomic mass units (amu). Ideally, the fluorinated oil will have a Mn of 10,000 to 30,000 amu.

Higher molecular weight oil (greater than 10,000 Mn molecular weight) in general has a higher viscosity than lower molecular weight oil. The higher viscosity allows for a greater grease layer 60 thickness to be retained in the nip, which in turn enables the desired mixed lubrication in the high pressure area of the nip. Previously, a higher viscosity was created by adding filler. However, too much filler can increase the torque to an unacceptable level. Also, over time, the oil separates from the filler reducing the percentage of oil within the nip such that mixed lubrication cannot be maintained. The introduction of the higher molecular weight oil allows for a thicker grease layer 60 with a smaller amount of fillers. Accordingly, the percentage of the grease layer 60 that is oil is much higher. Because the percentage of oil begins at such a high level, mixed lubrication may be maintained even with the inevitable oil loss over the life of the fuser 34. By maintaining mixed lubrication, torque and low level vibration noise is reduced, which increases the effective lifetime of the fuser 34.

As discussed above, the higher viscosity mixture which was achieved by adding fillers can be replaced with a grease of higher molecular weight. One or more types of filler may be included with the lubricant composition 60, in an amount effective to provide high enough viscosity to maintain the lubricant in the nip. One useful filler is polytetrafluoroethylene (PTFE). The filler content must be high enough to prevent oil separation in the nip area. However, if the filler content is too high, increased torque may result from the increased contact resistance between the heater 50 and belt surface 40. There is a balance between having enough filler to retain the lubricant composition 60 in the nip area yet still achieving low torque and good thermal contact between fuser 34 components. To maintain low torque throughout the useful life of the fuser 34, friction modifiers (another type of filler) may be included with the lubricant composition 60. In one exemplary approach, tungsten disulfide may be used as a friction modifier to reduce surface friction. The tungsten disulfide has an affinity for the metallic belt 40.

In one exemplary approach, the lubricant composition 60 includes a fluorinated base oil, a polytetrafluoroethylene (PTFE) filler, and Tungsten Disulfide friction modifier. One example of a suitable product which meets the above requirements for a lubricant composition 60, and which is commercially available, can be obtained under the product name Tribolube 7® from Aerospace Lubricants Inc of Columbus, Ohio. Another example of a commercially available grease that can also be used for the lubricant composition 60, and is considered equally successful, without the addition of tungsten disulfide, can be obtained under the product name Tribolube 8® (also from Aerospace Lubricants). Other lubricant compositions may be used, as long as these compositions have the properties described herein.

As noted, the lubricant composition hereof may be modified by adding one or more fillers thereto. Additionally, where used, the particle size of the filler should be less than 5 microns with an ideal range being 10 to 500 nm.

The viscosity of the exemplary lubricant composition was compared to the viscosity of a conventional grease previously used in these systems, as shown in Table 1 and FIG. 3. Here it is shown that the viscosity at the desired shear rate and temperature is double that of the previous grease used.

TABLE 1
Properties of Tested Greases at 25° C..

| Material | Viscosity (Pa-s) |
|---|---|
| New lubricant composition | 9.02 |
| Low MW oil with 17% PTFE content | 5.74 |
| Low MW oil | 0.72 |

Table 2 provides the chemical structure and number average molecular weight (Mn) of the base oil as determined by nuclear magnetic resonance spectroscopy (NMR), which demonstrates that the new lubricant composition has a much greater molecular weight than previously used oils.

TABLE 2
Comparison of molecular weight (Mn) of base oils.

| Grease | Oil Structure | Base Oil Mn | % Filler |
|---|---|---|---|
| New lubricant | copolymer poly | 30,000 | 20% |
| composition | (perfluoromethylene) oxide | | Total |
| | and poly(perfluoroethylene) | | |
| | oxide | | |
| Low MW oil with | polyperfluoropropylene oxide | 7,000 | 17% |
| 17% PTFE | | | Total |

After testing fusers 34 with different exemplary lubricants 60 by running them for life in an image-forming device 10, the greases in the nip areas were removed and analyzed. In the case of the new lubricant composition, the percent of oil remaining in the nip area after running to life was 75%. Ideally there would be 80% oil. Thus, a 6.25% loss of oil in the nip was observed. On average with previously used lubricants, as much as 30% to 35% of the oil has been lost from the nip. Moreover, visual inspection of the new lubricant composition 60, after testing, shows a continuous film in the nip area. In contrast, previously used lubricants left noticeable dry patches, that lacked lubrication, in the nip.

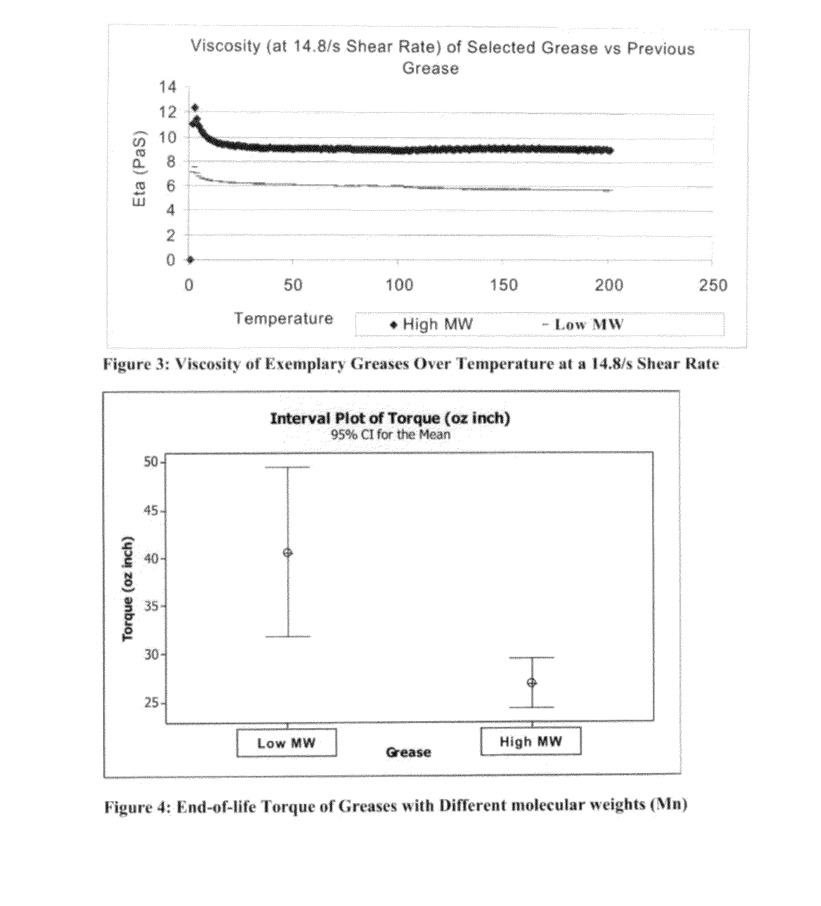

The torque has also been measured for fusers 34 run with the two different lubricant compositions at the beginning of product life and at the end of life to confirm the effect of the oil retention in the nip. FIG. 4 depicts the results of the torque analysis. In particular, FIG. 4 shows that the fuser 34 with the new lubricant composition 60 has a significantly lower torque at the end of life. Though not depicted in FIG. 4, the fuser 34 with the new lubricant composition actually starts off with a higher torque, but reduces dramatically over the life of the fuser assembly, as the oil is distributed over the components. In contrast, the fuser 34 applied with the conventional lubricant composition starts off with a low initial torque that increases over time, as the oil is lost from the nip.

Accordingly, the lubricant composition 60 with a higher molecular weight provides for greater retention of oil in the nip over the lifespan of the fuser 34. Belt-based fusers 34 depend on grease to lubricate the interface of the belt 40 with the heater 50. The pressure exerted by the pressure roller 42 along with the heat from the heater 50 can result in boundary lubrication, or a loss of oil in the nip. Such boundary lubrication causes increasing torque and can reduce the lifespan of the fuser and affect print quality. While adding fillers to the grease can add to the viscosity thereof, they reduce the percentage of oil in the nip. However, greases with a high molecular weight provide high viscosity with minimal fillers, thereby increasing the percentage of oil in the nip.

The foregoing description has been presented for purposes of illustration. It is not intended to be exhaustive or to limit the below-listed claims to the precise steps and/or forms disclosed, and those in the art will realize that many modifications and variations are possible in light of the above teaching. It is intended that the scope of the invention be defined by the claims appended hereto, rather than by the foregoing description.

1. A fuser assembly for an image-forming device, comprising:
a heating element;
a belt disposed about the heating element; and
a lubricant layer disposed between the belt and the heating element, wherein the lubricant layer comprises a fluorinated oil with a number average molecular weight (Mn) of at least 10,000 atomic mass units (amu).

2. The fuser according to claim 1, wherein the lubricant layer further comprises a tungsten disulfide friction modifier.

3. The fuser according to claim 1, wherein the lubricant layer at 25 C and a shear rate 14.8/s provides a viscosity of at least 7 PaS.

4. The fuser according to claim 1, wherein the number average molecular weight of the fluorinated oil is in the range of 10,000 to 50,000 amu.

5. The fuser according to claim 1, wherein the fluorinated oil comprises a perfluoropolyether.

6. The fuser according to claim 1, wherein the fluorinated oil further comprises a copolymer of polyperfluoromethylene oxide and polyfluoroethylene oxide.

7. The fuser according to claim 6, wherein the number average molecular weight of the fluorinated oil is in the range of 10,000 to 50,000 amu.

8. The fuser according to claim 7, wherein the lubricant further includes a PTFE filler having particles in a size less than 5 microns.

9. The fuser according to claim 8, wherein the particle size of the filler is in a range of 10 to 500 nm.

10. A fuser assembly for an image-forming device, comprising:
a heating element;
a belt disposed about the heating element; and
a lubricant layer disposed between the belt and the heating element, wherein the lubricant layer comprises: a fluorinated oil comprising a copolymer of polyperfluoromethylene oxide and polyfluoroethylene oxide; and a tungsten disulfide friction modifier.

11. The fuser according to claim 10, wherein said fluorinated oil having a number average molecular weight (Mn) of at least 10,000 atomic mass units (amu).

12. The fuser according to claim 11, wherein the number average molecular weight of the fluorinated oil is in the range of 10,000 to 50,000 amu.

13. A method of extending the life of a fuser apparatus for an image-forming device, said method comprising the steps of:
a) applying a lubricant layer to an inner surface of a belt in an area between the belt and a heating element of said fuser apparatus; and
b) operating said image forming device to rotate said belt around said heating element; wherein the lubricant layer comprises a fluorinated oil with a number average molecular weight (Mn) of at least 10,000 atomic mass units (amu).

14. The method of claim 13, wherein the lubricant layer further comprises a tungsten disulfide friction modifier.

15. The method of claim 13, wherein the lubricant layer at 25 C and a shear rate 14.8/s provides a viscosity of at least 7 PaS.

16. The method of claim 13, wherein the number average molecular weight of the fluorinated oil is in the range of 10,000 to 50,000 amu.

17. The method of claim 13, wherein the fluorinated oil comprises a perfluoropolyether.

18. The method of claim 17, wherein the fluorinated oil further comprises a copolymer of polyperfluoromethylene oxide and polyfluoroethylene oxide.

19. The method of claim 16, wherein the lubricant further includes a PTFE filler having particles in a size less than 5 microns.

20. The method of claim 19, wherein the particle size of the filler is in a range of 10 to 500 nm.
